(19) United States
(12) Patent Application Publication
(10) Pub. No.: US 2015/0219152 A1
(43) Pub. Date: Aug. 6, 2015

(54) END FACE OIL CONFIGURATION FOR JOURNAL BEARINGS

(71) Applicant: BORGWARNER INC., Auburn Hills, MI (US)

(72) Inventor: Daniel N. Ward, Asheville, NC (US)

(21) Appl. No.: 14/429,239

(22) PCT Filed: Sep. 19, 2013
(86) PCT No.: PCT/US2013/060570

§ 371 Date: Mar. 18, 2015

Related U.S. Application Data
(60) Provisional application No. 61/708,735, filed on Oct. 2, 2012.

(51) Int. Cl. F16C 32/06; F01D 25/16

(52) U.S. Cl. CPC F16C 32/0629; F01D 25/166; F05D 2220/40

(57) ABSTRACT

A journal bearing, such as for a turbocharger, having an axial end face designed for improved balance of lubrication and thrust. The journal bearing axial end face is modified so that it provides thrust, yet does not easily allow oil to escape before allowing lubrication to take place between the bearing and the adjacent face.

### FIELD OF THE INVENTION

The present invention relates to turbochargers for internal combustion engines and more particularly to a journal bearing having an axial face designed for improved balance of lubrication and thrust. More specifically, the invention provides a journal bearing with which flow of oil can be reduced, yet reliably maintained even when the shaft is experiencing axial load.

### BACKGROUND OF THE INVENTION

Turbochargers are widely used to increase performance of internal combustion engines. Hot exhaust gases drive a turbine rotor, which drives a compressor rotor via a turbocharger shaft. Temperatures of about 740° C. occur in the exhaust gas turbine in the case of Diesel engines and above about 1,000° C. in the case of Otto-cycle engines. Automotive turbochargers operate at extremely high rotational speeds, sometimes in excess of 200,000 RPM. In spite of these harsh conditions, it is now necessary to design engine components for reliable operation in excess of 200,000 miles of operation. This means that it is essential to ensure adequate lubrication of the bearing devices.

The turbocharger shaft is rotationally supported on journal bearings, often floating bearings spaced apart by a bearing spacer. To deliver lubricating oil to the critical wear points of a turbocharger using two floating journal bearings, oil is typically delivered under high pressure to the top of the journal bearings and is channeled through radial bores inwardly to the interface between the shaft and the inside diameter of the journal bearing. At their axial ends, the journal bearings have bearing surfaces which must accommodate both rotational forces and axial forces.

It is critical that oil flows without interruption over the axial surfaces of the journal bearings. However, axial movement of the shaft and shaft-mounted-members can reduce the space between the adjacent members and restrict circulation of oil. As a result of reduced oil circulation the metal surfaces and/or the oil can become hotter, thereby reducing the effectiveness of the oil and increasing the wear on the parts. To compensate, it is known to increase the flow of oil through the bearing housing of a turbocharger. However, this increased flow of oil at the journal bearing axial outer surface would be directly adjacent the piston seals, and thus precisely at the point of greatest vulnerability to leakage, increasing the opportunity for oil to leak from the bearing housing into the turbine or compressor portions of the turbocharger. Lubricating oil in the turbine housing and will be expelled directly with the exhaust flow out of the engine into the atmosphere. Lubricating oil entering the compressor housing will be injected into the combustion chamber of the engine where it will not be properly burned and will be emitted by the engine as an undesired hydrocarbon pollutant. It is commonly believed that over half of the hydrocarbon emissions of turbocharged engines come from oil leakage through the turbocharger, not from the engine itself.

Thus, there is a need on the one hand to achieve longer service life of a turbocharger which would suggest that oil flow should be increased, and on the other hand, a need to reduce hydrocarbon emissions, indicating that oil flow through the bearing housing should be minimized to decrease the opportunity for oil leakage into the turbine or compressor housings of the turbocharger.

To ensure good lubricating oil flow at the axially outer end faces of the bearings without increasing total flow volume, it has been proposed to provide radially-extending wedge-shaped grooves on the journal bearing end faces, allowing flow of “spent” oil from the shaft radially outward to escape to the drain cavity of the bearing housing. See, for example, Wollenweber U.S. Pat. Nos. 3,390,926 and 3,993,370 teaching radially extending grooves on both axial end faces of the shaft mountable member (e.g., journal bearing). The grooves are provided with a “V” shape with an angle of 150° for generating an axial force between the bearing and the adjacent member, and oil provided under pressure works in combination with the 150° grooves to provide a thrust function.

Ward U.S. Pat. No. 6,709,160 teaches that an axial end face of the journal bearing is provided with a plurality of radial grooves to permit radial flow of lubricating oil across the end face, thereby lubricating the thrust surface between the journal bearing and a shoulder on the bearing housing. The grooves are structured to communicate the fluid therethrough without generating a significant thrust loading.

The present inventor reviewed currently available journal bearing end face designs, and it occurred to him that in journal bearings in which the end faces are provided with radially-extending wedge-shaped grooves for the purpose of developing an axial thrust load, the oil in these grooves is more likely to be pumped out of the open outer end of the groove due to centrifugal force than effectively develop axial thrust load. The inventor noted that even in journal bearings with end faces provided with complex ramps or pads to increase thrust, these journal bearings are also provided with radial grooves for escape of spent oil, and thus are liable to the same problem.

The inventor considered that there exists a need for a journal bearing with improved balance of lubrication and thrust loading.

It is therefore a primary object of the invention to provide a turbocharger bearing system characterized by a highly efficient, accurate, controlled lubrication system that permits excellent lubrication of the bearing axial end faces with a minimum of oil flow through the bearing housing, thereby providing a turbocharger that is reliable and durable in operation.

Another object of the invention is to provide a turbocharger bearing assembly that will reduce the amount of oil that is leaked into the engine intake or exhaust streams, thereby reducing the hydrocarbon emissions of the engine.

A further object of the invention is to accomplish the above objects while providing a turbocharger bearing assembly that is simple in design and easy to manufacture.

### SUMMARY OF THE INVENTION

The inventor re-designed the journal bearing axial end face to provide a configuration that does not easily allow oil to escape before allowing lubrication to take place between the bearing and the adjacent face.

This is accomplished by providing the axial end face of the journal bearing with two functionally distinct features. The thrust face is generally planar. However, in a radially inner area, recessed features are provided to generate a pressurized oil film. Radially outward of these features, the planar face is a contiguous planar face, i.e., devoid of grooves or other features for radial passage of oil. Thereby, the outer area functions as a hydrodynamic “dam”, assisting in building up a reservoir of oil under pressure in the radially inner area. This design provides improved flow under all conditions. The “dam” ensures that oil does not simply flow out of radial grooves in the case of increased thrust loads, but rather ensures that oil remains in the radially inner area to warranty the thrust load function of the inner area.

With this inventive design of journal bearing end face, it becomes unnecessary to increase oil flow due to concern over restricted oil flow. Rather, it becomes possible to reduce the total turbocharger oil flow rate, thus reducing emissions, without concern over inadequate oil flow under axial load at a floating rotating journal bearing end face.

### BRIEF DESCRIPTION OF THE DRAWINGS

The present invention is illustrated by way of example and not limitation in the accompanying drawings in which like reference numbers indicate similar parts, and in which:

FIG. 1 depicts a first embodiment of an inventive journal bearing end face of the of the invention;

FIG. 2 depicts a second embodiment of the end face of the journal bearing of the invention; and

FIG. 3 depicts a third embodiment of the end face of the journal bearing of the invention.

### DETAILED DESCRIPTION OF THE INVENTION

A journal bearing having an end face according to the present invention is improved particularly in warranting oil flow under conditions of axial thrust, but requires no modification of the turbocharger other than substitution of the inventive journal bearing for the conventional journal bearing. The journal bearing may be a “floating” journal bearing having a three piece design, with two journal bearings separated by a bearing spacer, or may be a “pinned” journal bearing of a one piece design or a three piece design. Thus, the operation of a turbocharger, and in particular the operation of journal bearings, need not be described herein. Reference may be made to the disclosure in, e.g., U.S. Pat. No. 6,709,160 for “floating” bearings and U.S. Pat. No. 6,017,184 for “pinned” bearings.

The three journal bearings shown in the figures each have an axial end face 1 with a radially outer area and a radially inner area. These areas have different functions and accordingly different characteristic design features.

The radially inner area is provided with recessed features 2a, 2b, 2c designed to generate a pressurized oil film between the journal bearing planar end face and the opposite thrust surface, which may be a static face (e.g., bearing housing) or a rotating face (e.g., shoulder of turbocharger shaft).

The radially outer area includes a contiguous planar face, provided for the purpose of hindering passage of oil, thereby ensuring sufficiency of oil volume and oil pressure in the radially inner zone, enabling lubrication to take place between the journal bearing end face and the adjacent thrust surface, and preventing metal-to-metal contact, even under conditions in which axial thrust is generated by the rotating assembly.

Thereby, the outer area functions as an imperfect or “quasi” seal adequate to assist in impeding loss of oil pressure in the inner area. If the rotating assembly (including turbocharger shaft, compressor wheel and turbine wheel) applies increased axial load to this end face (e.g., during sudden acceleration), axial pressure may cause the shaft to move axially, reducing the “seal gap”. If the radially outward escape of oil is hindered due to the absence of escape routes in the outer area in accordance with the present invention, oil volume and pressure builds up in the inner area, and the thrust load function of the inner area is improved, whereupon the seal gap spacing is restored but under increased pressure, which translates into increased axial thrust to meet the increased axial load introduced by the rotating assembly.

The thrust surfaces at the end faces of the bearings may be of a variety of types; for example, the bearing end faces may carry, in the inner area, radial grooves, preferably of V-shaped cross-section wherein the sides of each groove form an included angle of approximately 150°. In accordance with the present invention, the radial grooves do not extend across the radially outer area, and do not provide opportunity for unimpeded escape of oil.

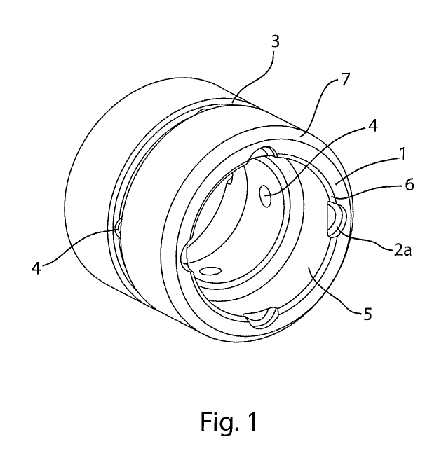

FIG. 1 shows recessed thrust-increasing areas 2a as produced by, e.g., axial movement of a round cutting tool or radial movement of a drill. A journal bearing produced in this manner can be simply produced by machining an “off the shelf” journal bearing, so long as the machined away area intersects only the inner diameter of the axial end face, and not the outer diameter.

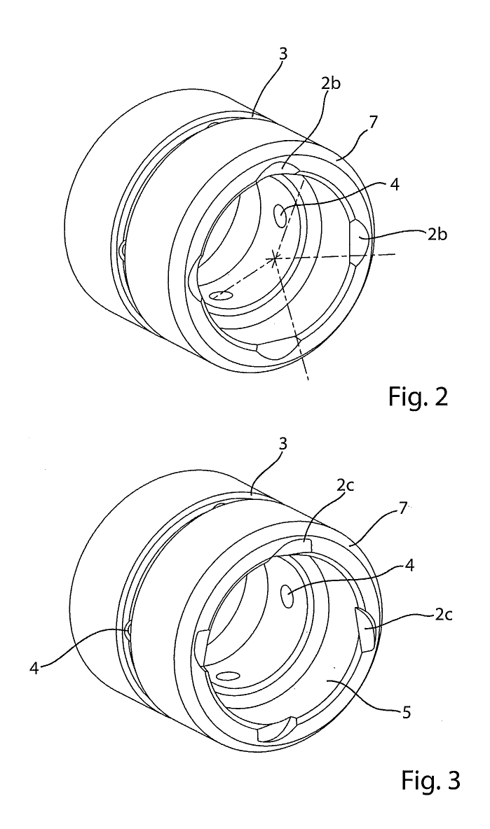

FIG. 2 shows thrust-increasing area 2b wherein material removal is accomplished by milling or machining, but with the tool moved outward at an angle to the axis of the bore rather than produced by moving the tool parallel to the axis of the bore as in FIG. 1.

FIG. 3 shows a wedge-shaped recessed ramp produced by tilting the cutting tool at an angle to the plane which lies perpendicular to the central axis of the journal bearing.

In the illustrated embodiments oil is delivered under pressure (e.g., from the lubrication system of an internal combustion engine) to a central depressed area 3 of the outer circumference of the journal bearing, and migrates through radial bores 4 to the inner diameter 5 of the journal bearing. This oil migrates along the gap between shaft and journal bearing bore until it reaches an axial end of the journal bearing, at which point it is spun generally radially outwardly due to centripetal force. Optionally, if it is desired to further increase the oil supply to the thrust surfaces on the ends of the bearing, each journal bearing may be provided with one or more axial bore communicating with a radial bores 4 carrying the pressurized oil, and supplying oil to e.g., one or more of the recessed features 2a, 2b, 2c provided in the inner area of the end face. Thus, a direct supply of cool oil is introduced to all thrust surfaces. However, in the preferred embodiments of the invention such supplemental axial flow channels are not required since sufficiency of oil is ensured by the oil-flow-controlling function of the contiguous outer planar feature of the axial end face.

As a further alternative construction, grooves might be provided in the inner journal surfaces of the bearing for the purposes of carrying oil to the thrust-bearing surfaces, but again, this is not necessary, and it is the object of the invention to provide continuous lubrication with reduced oil flow.

In a preferred embodiment of the invention, the journal bearing end faces are provided with chamfers; an inner chamfer 6 at the intersection of the journal bearing bore or inner surface and the axial end face, and an outer chamfer 7 at the intersection of the journal bearing outer surface and axial end face. The chamfers may be provided at only one axial end of the journal bearing or at both the inboard and outboard ends. Chamfers not only facilitate assembly of journal bearings onto shafts and into bores, but also promote flow of lubricating oil.

Preferably, both axial ends of the journal bearing are provided with the same features, so that the journal bearings cannot be “reverse mounted” during manual assembly of the turbocharger. Accordingly, these journal bearings are compatible with modern turbocharger high production rate manufacturing criteria.

Since the journal bearing of the present invention is efficient and effective, oil flow can be reduced, thereby producing a turbocharger capable of a very long useful life while still reducing the amount of lubricant necessary to achieve these ends, and, therefore, significantly reducing the amount of hydrocarbon emissions caused by the turbocharger.

The inner and outer diameters of the journal bearing may be circular, i.e., tubular, or may be provided with lands.

The journal bearing shown in the figures is one journal bearing of a system generally comprising two journal bearings separated by a bearing spacer, but in practice the journal bearing of the invention may be a one-piece journal bearing, supporting both compressor end and turbine end of the shaft. The bearing may be free floating or may be “pinned” and thus semi-floating.

Various modifications and changes may be made by those having ordinary skill in the art without departing from the spirit and scope of this invention. Therefore, it must be understood that the illustrated embodiments of the present invention have been set forth only for the purpose of example, and that they should not be taken as limiting the invention as defined in the following claims. The journal bearing could be one piece or could be three-piece. The journal bearing could be “pinned” or could be free floating.

Now that the invention has been described, I claim:

1. A journal bearing for a rotating shaft, said bearing including at least one axial end face, said end face including:
a planar surface, and
one or more recessed thrust-producing feature adapted for increasing thrust at the axial end face,
wherein said planar surface provides a contiguous annular surface radially outwardly of said one or more recessed thrust-producing feature.

2. The journal bearing as in claim 1, wherein the outer diameter of the planar axial end face is circular.

3. The journal bearing as in claim 1, wherein the non-planar features for generating thrust load include ramp features.

4. The journal bearing as in claim 1, wherein the end face includes two or more non-planar features for generating thrust load.

5. The journal bearing as in claim 1, wherein the journal bearing includes an outer surface adapted to being received in a bearing housing bore, and wherein the journal bearing includes on the outer surface a central depressed area (3) and further includes radial bores (4) between the central depressed area (3) and the journal inner diameter.

6. The journal bearing as in claim 5, further comprising one or more axial bores communicating with the radial bores (4) and one or more of the recessed features (2a, 2b, 2c).
